(19) United States
(12) Patent Application Publication
(10) Pub. No.: US 2014/0160990 A1
(43) Pub. Date: Jun. 12, 2014

(54) Mechanisms for Quality of Service to Over the Top Applications for Use in Commercial Wireless Networks

(71) Applicant: TeleCommunication Systems, Inc., Annapolis, MD (US)

(72) Inventors: Vineet Sachdev, Annapolis, MD (US); Keith McFarland, Annapolis, MD (US)

(73) Assignee: TeleCommunication Systems, Inc., Annapolis, MD (US)

(21) Appl. No.: 14/032,913

(22) Filed: Sep. 20, 2013

Related U.S. Application Data
(60) Provisional application No. 61/703,554, filed on Sep. 20, 2012.
(60) Provisional application No. 61/714,944, filed on Oct. 17, 2012.

(51) Int. Cl. H04W 72/10; H04W 24/02

(52) U.S. Cl. CPC H04W 72/10; H04W 24/02
USPC 370/259

(57) ABSTRACT

An over-the-top (OTT) application is integrated with a quality of service (QoS) server to enable the OTT application to request and get desired QoS treatment for application data traversing a commercial wireless network. When an OTT application client registers with an OTT application server, the OTT application server can send a QoS request message to the QoS server to request QoS control. The QoS server forwards QoS rules received in a QoS request message to a conventional policy and charging rules function (PCRF) on the client devices' home mobile network operator (MNO). If the client device is roaming, the PCRF on the home MNO forwards QoS rules to a PCRF on a serving MNO. QoS treatment is then carried out by the PCRF in a conventional manner. A connection between a QoS server and a PCRF is preferably established via a diameter Rx interface.

The present invention claims priority from U.S. Provisional No. 61/703,554, filed Sep. 20, 2012, entitled “Mechanisms for Quality of Service to Over the Top Applications For Use In Commercial Wireless Networks”; and from U.S. Provisional No. 61/714,944, filed Oct. 17, 2012, entitled “Mechanisms for Quality of Service to Over the Top Applications For Use In Commercial Wireless Networks”, the entirety of both of which are expressly incorporated herein by reference.

### BACKGROUND OF THE INVENTION

1. Field of the Invention

This invention relates generally to smart phone applications interacting with cloud based application infrastructure in an over the top (OTT) manner over Long Term Evolution (LTE) commercial wireless networks.

2. Background of Related Art

Verizon Wireless™ has recently become the first commercial service provider to fully launch a network with Long Term Evolution (LTE) 4G wireless broadband technology. Long Term Evolution (LTE) technology is a recent technology that supports a fast and efficient all-Internet Protocol (IP) network (i.e., a network that provides services, e.g., voice, video, data, messaging, etc., solely over the Internet). It is expected that the majority of commercial service providers will also adopt an all-Internet Protocol (IP) network at some point in the near future.

As the future of technology gears toward an all-IP network, the number of available over-the-top (OTT) applications is expected to increase. An over-the-top (OTT) application is an application that provides services/content to client user equipment (UE) over the Internet, absent the involvement of an Internet service provider (ISP). However, most over-the-top (OTT) applications (e.g., Skype, Netflix, etc.) are unable to benefit from quality of service (QoS) control mechanisms (e.g. priority, packet delay, guaranteed bit rate, etc.) available on today's commercial wireless networks (e.g. Long Term Evolution (LTE)). Rather, the majority of over-the-top (OTT) applications are forced to provide services on a best-effort basis (i.e., data delivery, efficiency not guaranteed).

Differentiated Services (DiffServ) is a service that specifies a mechanism for classifying and managing network traffic on modern Internet Protocol (IP) networks, for the purposes of providing quality of service (QoS) control. In particular, DiffServ uses a 6 bit field (i.e. a DS field) in an IP header for packet classification purposes.

In accordance with the DiffServ technology, a DS field can be influenced (set) by an application generating IP packets. However, although smart phone applications and application cores in the cloud can influence the setting of a DS field, there is no guarantee that an Internet Protocol (IP) network will honor a DS field setting and provide desired quality of service (QoS) control, being that: first, the honoring of a DS field is not mandated by current standards and, second, triggering quality of service (QoS) treatment in such a fashion defeats the purpose of quality of service (QoS) control as, conceivably, all types of data traffic flowing through an IP network could be marked for preferential treatment by a source application. Further, the quality of service (QoS) solution provided by DiffServ does not work when application data IP packets are encapsulated in a Virtual Private Network (VPN) tunnel.

As commercial wireless networks begin carrying data for over-the-top (OTT) mission critical applications, such as those applications used by emergency dispatch personnel and emergency first responders, a best-effort treatment of over-the-top (OTT) applications will no longer be acceptable. This is especially true in times of disaster, when networks are likely heavily congested. Hence, a successful means of extending quality of service (QoS) treatment to over-the-top (OTT) applications is needed.

### SUMMARY

A method and apparatus for extending quality of service (QoS) treatment to over-the-top (OTT) applications for use in a commercial wireless network, comprises a quality of service (QoS) server. In accordance with the principles of the present invention, an over-the-top (OTT) application server is integrated with a quality of service (QoS) server via a conventional hypertext transfer protocol (HTTP) (including extensible markup language (XML)/restful application programming interface(s) (API)), to enable the over-the-top (OTT) application server to request and get desired quality of service (QoS) treatment for application data that is traversing a commercial wireless network (e.g. a long term evolution (LTE) network).

In accordance with the principles of the present invention, the quality of service (QoS) server forwards desired quality of service (QoS) rules embedded in a quality of service (QoS) request message received from an over-the-top (OTT) application server, to a policy and charging rules function (PCRF) on an over-the-top (OTT) application client devices' home mobile network operator (MNO). If a client device is roaming, then the policy and charging rules function (PCRF) on the client devices' home mobile network operator (MNO) forwards received quality of service (QoS) rules to a policy and charging rules function (PCRF) serving the client device. Quality of service (QoS) treatment is then carried out in a conventional manner by the serving policy and charging rules function (PCRF).

In accordance with the principles of the present invention, a connection between a quality of service (QoS) server and a policy and charging rules function (PCRF) is preferably established via a diameter Rx interface. Accordingly, the primary function of a quality of service (QoS) server is to translate diameter protocol messages to other communication mediums and vice versa.

In accordance with the principles of the present invention, an over-the-top (OTT) application must provide identification and register services and application characteristics with a quality of service (QoS) server before the application is permitted to request quality of service (QoS) treatment therefrom. During registration with a quality of service (QoS) server, an over-the-top (OTT) application is required to provision one or more quality of service (QoS) application profiles, each indicating a desired level of quality of service (QoS).

In accordance with the principles of the present invention, a quality of service (QoS) application profile ID, identifying a particular quality of service (QoS) application profile, is included in each quality of service (QoS) request message sent to the quality of service (QoS) server. A quality of service (QoS) application profile ID indicates to the quality of service (QoS) server a particular quality of service (QoS) application profile to invoke.

When an over-the-top (OTT) application server detects a termination of signaling or service on an over-the-top (OTT) application client device, the over-the-top (OTT) application server sends a quality of service (QoS) termination message to the quality of service (QoS) server, to indicate that reserved quality of service (QoS) values may be terminated on the client devices' home mobile network operator (MNO).

### BRIEF DESCRIPTION OF THE DRAWINGS

Features and advantages of the present invention will become apparent to those skilled in the art from the following description with reference to the drawings, in which:

FIG. 1 depicts an exemplary network structure for extending quality of service (QoS) treatment to over-the-top (OTT) applications for use in a commercial wireless network, in accordance with the principles of the present invention.

FIG. 2 depicts an exemplary quality of service (QoS) server architecture, in accordance with the principles of the present invention.

FIG. 3 depicts an exemplary process flow for extending quality of service (QoS) treatment to an over-the-top (OTT) application on a commercial wireless network, in accordance with the principles of the present invention.

### DETAILED DESCRIPTION OF ILLUSTRATIVE EMBODIMENTS

The present invention enables an over-the-top (OTT) application to request and get desired quality of service (QoS) treatment, when data transmitted to/from the over-the-top (OTT) application is traversing a commercial wireless network (e.g. a long term evolution (LTE) network).

New wireless standards, such as long term evolution (LTE), only specify data connectivity, and do not specify any applications. Applications, rather, are expected to be facilitated via carrier-hosted application frameworks (e.g. an internet multimedia system (IMS)).

To ensure that applications carried out via carrier-hosted application frameworks are operating at a desired level of quality of service (QoS) (e.g. packet delay, priority, etc.), new wireless standards have defined a policy and charging rules function (PCRF). A policy and charging rules function (PCRF) is a network element (in a long term evolution (LTE) packet core) that may be accessed by carrier-hosted application frameworks (e.g. IMS) via a diameter protocol based interface (Rx), for the purposes of providing quality of service (QoS) treatment to applications.

Unfortunately, applications to which policy and charging rules functions (PCRF) are expected to extend quality of service (QoS) treatment, do not include over-the-top (OTT) applications. An over-the-top (OTT) application is an application that provides services/content to a client user equipment (UE) over the Internet, absent the involvement of an Internet service provider (ISP). Since conventional over-the-top (OTT) applications are not facilitated via carrier-hosted application frameworks, they are not able to benefit from quality of service (QoS) treatment available on today's commercial wireless networks. Rather, conventional over-the-top (OTT) applications are forced to operate on a best-effort basis (i.e. data delivery, efficiency not guaranteed).

With the future of technology gearing towards an all IP-network (e.g. a long term evolution (LTE) network), over-the-top (OTT) applications are expected to become increasingly common. As commercial wireless networks begin carrying data for over-the-top (OTT) mission critical applications, such as those applications used by emergency dispatch personnel and emergency first responders, a best effort treatment of over-the-top (OTT) applications will no longer be acceptable.

The present invention extends quality of service (QoS) treatment available on today's commercial wireless networks (e.g. long term evolution (LTE) networks) to over-the-top (OTT) applications, without burdening over-the-top (OTT) applications with network integration aspects, such as: support for diameter protocol (a support that is not commonly found in web applications), knowledge of user location, knowledge of a policy and charging rules function (PCRF), knowledge of a long term evolution (LTE) packet core, etc.

In accordance with the principles of the present invention, over-the-top (OTT) applications are integrated with an inventive quality of service (QoS) server via a conventional hypertext transfer protocol (HTTP) (including extensible markup language (XML)/restful application programming interface(s) (API)) to enable quality of service (QoS) treatment to be extended thereto. Once an over-the-top (OTT) application is integrated with a quality of service (QoS) server, the over-the-top (OTT) application may request and get desired quality for service (QoS) treatment for application data that is traversing a commercial wireless network, e.g., long term evolution (LTE), Wi-Fi, etc.

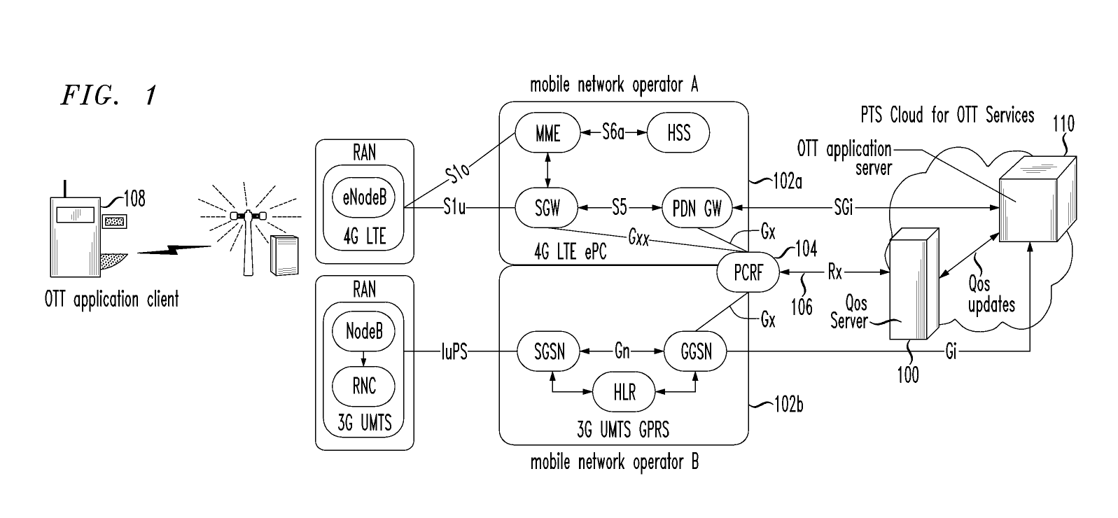

FIG. 1 depicts an exemplary network structure for extending quality of service (QoS) treatment to over-the-top (OTT) applications for use in a commercial wireless network, in accordance with the principles of the present invention.

In particular, as depicted in FIG. 1, a quality of service (QoS) server 100 is configured to directly interface with one or more commercial wireless networks 102a, 102b, via a conventional policy and charging rules function (PCRF) (i.e. an IP multimedia subsystem (IMS)/long term evolution (LTE) network component) 104. In accordance with the principles of the present invention, a connection between a quality of service (QoS) server 100 and a policy and charging rules (PCRF) 104 is preferably established via a diameter Rx interface 106 (3GPP specifications 29.209, 29.214). Hence, the primary function of a quality of service (QoS) server 100 is to translate diameter protocol interface 106 messages to other communication mediums and vice versa.

Once a connection is established between a policy and charging rules function (PCRF) 104 and a quality of service (QoS) server 100, the inventive quality of service (QoS) server 100 takes on the role of a special application function (AF) connected on the backend (i.e. not accessible to a user) of one or more disparate applications. The quality of service (QoS) server 100 must be able to communicate with backend applications and carrier policy and charging rules (PCRF) function(s) 104, simultaneously. Simultaneous communication may be permitted via a firewall setting, a virtual private network (VPN) connection, and/or other relevant rules.

In accordance with the principles of the present invention, when an over-the-top (OTT) application client 108 initiates registration with an over-the-top (OTT) application server 110, the over-the-top (OTT) application server 110 may send a quality of service (QoS) request message to the inventive quality of service (QoS) server 100 to request that quality of service (QoS) control be implemented on over-the-top (OTT) application data traversing a commercial wireless network 102a, 102b.

The quality of service (QoS) server 100 provides quality of service (QoS) control to the over-the-top (OTT) application by forwarding desired quality of service (QoS) rules received in a quality of service (QoS) request message to a policy and charging rules function (PCRF) 104 on the over-the-top (OTT) application client devices' 108 home mobile network operator (MNO) 102a, 102b. If the client device 108 is roaming, then the policy and charging rules function (PCRF) 104 on the device's 108 home mobile network operator (MNO) 102a, 102b forwards quality of service (QoS) rules received thereon to a policy and charging rules function (PCRF) serving the client device 108.

A quality of service (QoS) server 100 may be located separate from a mobile network operator (MNO) 102, 102b or co-located with a mobile network operator (MNO) 102, 102b. Possible mobile network operator (MNO) integration targets currently include: a universal mobile telecommunications system (UMTS), long term evolution (LTE) technology, an evolved-universal mobile telecommunications system (E-UMTS), long term evolution (LTE) technology advanced, and Wi-Fi. The quality of service (QoS) server 100 may easily be extended to support additional network interfaces as technology evolves.

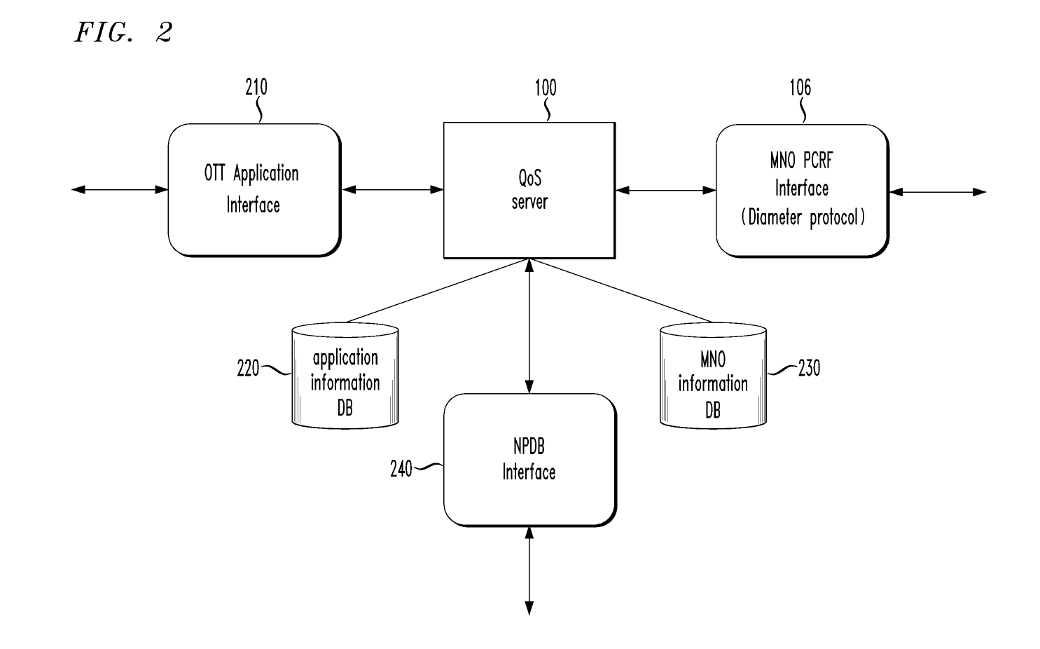

FIG. 2 depicts an exemplary quality of service (QoS) server architecture; in accordance with the principles of the present invention.

As portrayed in FIG. 2, the inventive quality of service (QoS) server 100 interacts with a mobile network operator (MNO) policy and charging rules function (PCRF) interface (a diameter protocol interface) 106, an over-the-top (OTT) application interface 210, and a number portability database (NPDB) interface 240, to extend quality of service (QoS) treatment to over-the-top (OTT) applications on commercial wireless networks.

In accordance with the principles of the present invention, the quality of service (QoS) server 100 maintains profiles and information for over-the-top (OTT) applications in a local application information database 220, as depicted in FIG. 2. Moreover, the quality of service (QoS) server 100 maintains home mobile network operator (MNO) information for over-the-top (OTT) application client devices in a local mobile network operator (MNO) information database 230.

If by chance the quality of service (QoS) server 100 is not able to find home mobile network operator (MNO) data for an over-the-top (OTT) application client in the local mobile network operator (MNO) information database 230, then the quality of service (QoS) server 100 accesses a number portability database (NPDB) interface 240 to retrieve home mobile network operator (MNO) information from an external number portability database (NPDB).

The over-the-top (OTT) application interface 210, as depicted in FIG. 2, is designed to operate over a secure, transport layer security (TLS)/secure sockets layer (SSL) communications channel that utilizes representational state transfer (REST) hypertext transfer protocol (HTTP), hypertext transfer protocol (HTTP), simple object access protocol (SOAP), extensible markup language (XML), etc., message formats. New mediums for the over-the-top (OTT) application interface 210 may be defined and used, as appropriate, as long as quality of service (QoS) message formats (i.e. attributes and corresponding values included in quality of service messages) conform minimally to quality of service (QoS) message formats (i.e. a quality of service (QoS) request message format, a quality of service (QoS) response message format, and a quality of service (QoS) termination message format) described herein.

As previously stated, the quality of service (QoS) server 100 uses a diameter Rx protocol (3GPP 29.214) to interface 106 with a mobile network operator (MNO) policy and charging rules function (PCRF) 104. A mobile network operator (MNO) policy and charging rules function (PCRF) interface 106, as depicted in FIG. 2, provides' discovery and addressing of a home policy and charging rules function (HPCRF) 104 assigned to an over-the-top (OTT) application client device. In accordance with the principles of the present invention, the quality of service (QoS) server 100 assumes the role of an application function (AF) and complies with policy and charging rules function (PCRF) discovery and addressing, as described in a 3GPP series 29.213 specification. In support of this 3GPP series 29.213 specific cation, the quality of service (QoS) server 100 preferably maintains a table with a fully qualified domain name (FQDN) or internet protocol (IP) address of a policy and charging rules function (PCRF) for each supported single policy and charging rules function (PCRF) mobile network operator (MNO), and a diameter routing agent, for each supported multi-policy and charging rules function (PCRF) mobile network operator (MNO).

In accordance with the principles of the present invention, the quality of service (QoS) server 100 interfaces with a home policy and charging rules function (HPCRF) 104, regardless as to whether or not a client user equipment (UE) is roaming. A home policy and charging rules function (HPCRF) 104 coordinates a download of quality of service (QoS) rules to a visiting policy and charging rules function (VPCRF) in a roaming network (per 3GPP standards) when a requesting client user equipment (UE) is roaming.

In accordance with the principles of the present invention, a number portability database (NPDB) and the local mobile network operator (MNO) information database 230, as depicted in FIG. 2, each support multiple transaction capabilities application part (TCAP) based protocols (e.g., advanced intelligent network (AIN), intelligent network application protocol (INAP), American national standards institute ((ANSI)-41), etc.) for number portability queries, since such protocols support queries from both wireline and wireless networks based on various standards. In accordance with the principles of the present invention, the quality of service (QoS) server 100 preferably uses a number portability request (NPREQ) TCAP query (per telecommunications industry association/electronic industries association (TIA/EIA)-756A and telecommunications industry association/electronic industries association (TIA/EIA) ANSI41-D specifications) to determine a current mobile network operator (MNO) associated with an over-the-top (OTT) application client device. The quality of service (QoS) server 100 may easily be extended to support other protocols for number portability lookup.

In accordance with the principles of the present invention, an over-the-top (OTT) application must provide identification and register services and application characteristics with a quality of service (QoS) server 100 before that application may be permitted to request quality of service (QoS) treatment therefrom. For security purposes, the quality of service (QoS) server 100 only accepts registration attempts from over-the-top (OTT) applications for which the quality of service (QoS) server 100 has been pre-configured to accept registration attempts. Therefore, not all over-the-top (OTT) applications are permitted to register with a quality of service (QoS) server 100.

Moreover, over-the-top (OTT) applications that are granted registration With a quality of service (QoS) server 100 are only permitted to receive levels of quality of service (QoS) treatment for which they have been pre-authorized to receive. Quality of service (QoS) requests are validated by the quality of service (QoS) server 100 before they are processed.

In accordance with the principles of the present invention, an over-the-top (OTT) application is required to periodically register with a quality of service (QoS) server 100. During registration, an over-the-top (OTT) application identifies service abilities and may optionally request a desired level of quality of service (QoS) treatment.

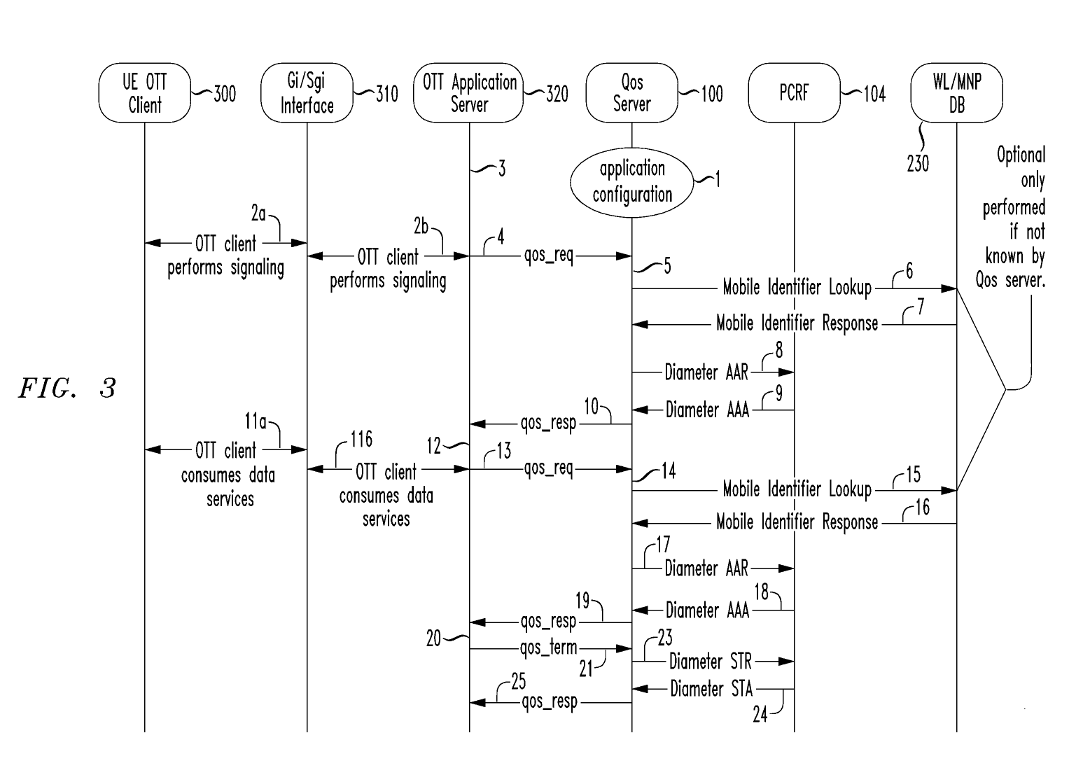

FIG. 3 depicts an exemplary process flow for extending quality of service (QoS) treatment to an over-the-top (OTT) application on a commercial wireless network, in accordance with the principles of the present invention.

In particular, as depicted in step 1 of FIG. 3, application configuration is performed on a quality of service (QoS) server 100 via an authenticated interface. During application configuration, a quality of service (QoS) server 100 is provisioned to accept a registration request from an identified over-the-top (OTT) application. In accordance with the principles of the present invention, an over-the-top (OTT) application also provisions one or more quality of service (QoS) application profiles during application configuration.

However, before an over-the-top (OTT) application can register and provision quality of service (QoS) application profiles at the quality of service (QoS) server 100, the quality of service (QoS) server 100 must first collect the following data from the over-the-top (OTT) application (more characteristics may be required as new application characteristics present themselves): an over-the-top (OTT) application identifier, over-the-top (OTT) access credentials, one or more quality of service (QoS) application profile IDs, over-the-top (OTT) application characteristics, and one or more mobile network operator (MNO) associations.

In accordance with the principles of the present invention, an over-the-top (OTT) application identifier is a unique string (synchronized with a carrier provided “AF-Application-Identifier”) that is provided to an over-the-top (OTT) application via an out-of-band mechanism. An over-the-top (OTT) application identifier may be prefixed with quality of service (QoS) unique identifiers for use on the quality of service (QoS) server 100.

Over-the-top (OTT) access credentials (e.g. a secret/password or public key infrastructure (PKI) verification) are a set of credentials agreed upon by an over-the-top (OTT) application and the quality of service (QoS) server 100 in an out of band manner.

In accordance with the principles of the present invention, a quality of service (QoS) application profile ID is a quality of service (QoS) specific value, defined per application identifier. More particularly, the quality of service (QoS) application profile ID is defined by the quality of service (QoS) server 100 and provided to an over-the-top (OTT) application via an out of band mechanism.

In accordance with the principles of the present invention, a quality of service (QoS) application profile ID points to a quality of service (QoS) application profile that is to be provisioned for an over-the-top (OTT) application. A quality of service (QoS) application profile contains application details (e.g. service characteristics, etc.) and indicates a desired level of quality of service (QoS). A quality of service (QoS) application profile ID is referenced in each quality of service (QoS) request message sent to the quality of service (QoS) server, to indicate to the quality of service (QoS) server a particular quality of service (QoS) application profile to invoke. In accordance with the principles of the present invention, an over-the-top (OTT) application may provision multiple quality of service (QoS) application profiles to indicate varying levels of desired quality of service (QoS).

Over-the-top (OTT) application characteristics provided to the quality of service (QoS) server during application configuration include (this list may be extended as new requirements develop, either by 3GPP specifications or via over-the-top (OTT) evolution): a media component number (i.e. an ordinal number of a media component), a media sub-component (i.e. a set of flows for one flow identifier), an application identifier, a media type (e.g. audio (0), video (1), data (2), application (3), control (4), text (5), message (6), other (0xFFFFFFFF)), a maximum requested bandwidth (Bw) uplink (UL), a maximum requested bandwidth (Bw) downlink (DL), a flow status, a reservation priority, RS bandwidth (Bw), RR bandwidth (Bw), and codec data.

In accordance with the principles of the present invention, a media sub-component field may include the following characteristics: a flow number (i.e. an ordinal number of the IP flow), a flow description (e.g. uplink (UL) and/or downlink (DL)), a flow status, flow usage, a maximum requested bandwidth (Bw) uplink (UL), a maximum requested bandwidth (Bw) downlink (DL), and an application function (AF) signaling protocol.

In accordance with the principles of the present invention, a mobile network operator (MNO) associations field provided to a quality of service (QoS) server during application configuration identifies all of the networks for which an over-the-top (OTT) application is authorized to designate quality of service (QoS) settings. Values in a mobile network operator (MNO) associations field are defined per quality of service (QoS) implementation and represent system logical identifiers for the purposes of routing communications to particular policy and charging rules (PCRF) functions.

In accordance with the principles of the present invention, once the above required application data has been furnished to the quality of service (QoS) server 100, an over-the-top (OTT) application provisions one or more quality of service (QoS) application profiles. When quality of service (QoS) application profiles have been provisioned for the over-the-top (OTT) application, the over-the-top (OTT) application may begin submitting registrations to the quality of service (QoS) server 100, on a per user equipment (UE) basis.

Once application configuration is complete, the over-the-top (OTT) application may begin sending quality of service (QoS) requests to the quality of service (QoS) server 100, on a per user equipment (UE) basis.

In particular, as depicted in steps 2a and 2b of FIG. 3, an over-the-top (OTT) application client 300 (residing on a mobile device) that has completed application configuration on the quality of service (QoS) server 100 performs signaling (registration, identification, etc.) to a corresponding over-the-top (OTT) application server 320 (via a Gi/SGi interface 310) to attempt registration therewith.

As shown in step 3, upon receiving the service registration request, the over-the-top (OTT) application server 320 attempts to establish a mutually authenticated (client 300 and server 320) transport layer security (TLS)/secure sockets layer (SSL) connection with the inventive quality of service (QoS) server 100 (via standard TLS/SSL procedures for mutual authentication).

As portrayed in step 4, if the initial mutual authentication step is successful, then the over-the-top (OTT) application server 320 sends a quality of service (QoS) request message to the quality of service (QoS) server 100.

In accordance with the principles of the present invention, a quality of service (QoS) request message preferably includes: a message ID (i.e. an identifier defined by, and unique to, a requesting over-the-top (OTT) application), an application identifier (as described in 3GPP series 29.214 specification), access credentials (e.g. a secret/password public key infrastructure (PKI) verification, etc.), a quality of service (QoS) application profile ID, a source framed internet protocol (IP) address (an attribute-value pair (AVP)) or framed IPv6 prefix (an attribute-value pair (AVP), RFC 4005 [12]), a service uniform resource name (URN) (an attribute-value pair (AVP), 3GPP 29.214), a reservation priority (TS 183.017 [15]) (a vendor ID shall be set to european telecommunications standards institute (ETSI) (13019) [15]), a subscription ID (RFC 4006 [14]) identifying a particular subscription (e.g. international mobile subscriber identity (IMSI), mobile subscriber integrated services digital network (MSISDN), etc.), and a flow description (an attribute-value pair (AVP), 3GPP 29.214).

A flow description in a quality of service (QoS) request message must comprise one of the following directions: ‘in’ or ‘out’, whereas direction ‘in’ refers to an uplink (UL) IP flow and direction ‘out’ refers to a downlink (DL) IP flow. A flow description in a quality of service (QoS) request message may also contain: a source and destination IP address (possibly masked), a protocol, and a source and destination port (a source port may be omitted to indicate that any source port is allowed). Lists and ranges may not be used to indicate source and/or destination ports.

A quality of service (QoS) application profile ID in a quality of service (QoS) request message indicates appropriate quality of service (QoS) information to send to a home policy and charging rules function (PCRF) 104.

In accordance with the principles of the present invention, the quality of service (QoS) server 100 performs quality of service (QoS) request validation in response to a quality of service (QoS) request message received thereon, as portrayed in step 5 of FIG. 3.

During quality of service (QoS) request validation, the quality of service (QoS) server 100 validates the application identifier, access credentials (e.g. a secret/password public key infrastructure (PKI) verification, etc.), and quality of service (QoS) application profile ID received in the quality of service (QoS) request message, against application profiles maintained in a local application information database 220. The quality of service (QoS) server 100 validates the format and values of quality of service (QoS) request message attributes, in accordance with a 3GPP series 29.214 specification.

When quality of service (QoS) request validation is complete, the quality of service (QoS) server 100 queries a local mobile network operator (MNO) information database 330 to retrieve home mobile network operator (MNO) information for the requesting client device 300, as depicted in step 6. If the quality of service (QoS) server 100 cannot find home mobile network operator (MNO) information for the requesting client device 300 in the local mobile network operator (MNO) information database 230, then the quality of service (QoS) server 100 alternatively queries an external number portability database (NPDB) via a number portability database (NPDB) interface 240. Results from either the number portability database (NPDB) or the local mobile network operator (MNO) information database 230 provide the quality of service (QoS) server 100 with enough information to determine a home mobile network operator (MNO) for the requesting client device 300.

Once a home mobile network operator (MNO) is identified for the requesting client device 300 (step 7), the quality of service (QoS) server 100 uses a quality of service (QoS) application profile ID, defined in the quality of service (QoS) request message, to determine whether or not the requesting over-the-top (OTT) application is authorized to influence quality of service (QoS) treatment on the home mobile network operator (MNO).

In step 8 of FIG. 3, if the over-the-top (OTT) application is permitted to influence quality of service (QoS) settings on the home mobile network operator (MNO), then the quality of service (QoS) server 100 sends a diameter authentication/authorization request (AAR) message with appropriate quality of service (QoS) information to a policy and charging rules function (PCRF) 104 on the home mobile network operator (MNO).

As portrayed in step 9, the policy and charging rules function (PCRF) 104 on the client devices' home mobile network operator (MNO) receives quality of service (QoS) information and returns a diameter authentication/authorization answer (AAA) message to the quality of service (QoS) server 100.

In step 10, the quality of service (QoS) server 100 sends a quality of service (QoS) response message with an appropriate status value to the over-the-top (OTT) application server 320.

In accordance with the principles of the present invention, a quality of service (QoS) response message preferably comprises: a message ID, an application identifier, and a status identifier.

The status identifier included in the status field of a quality of service (QoS) response message may be any one or more of the following: a success status identifier (100), a quality of service (QoS) system failure status identifier (200) (indicating a default failure or unexpected failure with no available details), a failed validation of application identifier/access credentials status identifier (201), a failed validation of quality of service (QoS) profile ID status identifier (202), a quality of service (QoS) system failure reserved message status identifier (defined per quality of service (QoS) implementation and used to explain a unique system failure) (203-299), a PCRF unavailable status identifier (300), and/or an AAR/AAA message failure status identifier (400), wherein the entire contents of the AAA message is embedded in the status field.

Once quality of service (QoS) rules have been forwarded to the policy and charging rules function (PCRF) 104 on the client devices' 300 home mobile network operator (MNO), the over-the-top (OTT) application client 300 can proceed to transmit and consume data for service delivery purposes (i.e. the over-the-top (OTT) client delivers a service as available to its' functionality and thereby consumes IP bandwidth as a result of service fulfillment). In particular, as depicted in steps 11a and 11b of FIG. 3, the over-the-top (OTT) application client device 300 either initiates or receives a request to begin service fulfillment.

As shown in step 12, once a request for service fulfillment is received (or initiated) on the over-the-top (OTT) application server 320 (via a Gi/SGi interface 310), the over-the-top (OTT) application server 320 attempts to establish a mutually authenticated (client 300 and server 320) transport layer security (TLS)/secure sockets layer (SSL) connection with the quality of service (QoS) server 100 (following standard transport layer security (TLS)/secure sockets layer (SSL) procedures for mutual authentication).

As portrayed in step 13, if the initial mutual authentication step is successful, the over-the-top (OTT) application server 320 sends a quality of service (QoS) request message to the quality of service (QoS) server 100 with a quality of service (QoS) application profile ID indicating a desired level of quality of service (QoS).

As depicted in steps 14-19, the quality of service (QoS) server 100 then performs quality of service (QoS) request validation on the received quality of service (QoS) request message, identifies a home mobile network operator (MNO) for the requesting client user equipment (UE) 300, sends appropriate quality of service (QoS) data to a home policy and charging rules function (PCRF) 104, and subsequently forwards a quality of service (QoS) response message to the over-the-top (OTT) application server 320, as previously described in steps 5-10.

In accordance with the principles of the present invention, once signaling or data services are terminated on the client user equipment (UE) 300, the over-the-top (OTT) application server 320 informs the quality of service (QoS) server 100 of the service termination, to trigger reserved quality of service (QoS) values to be terminated on the client devices' home mobile network operator (MNO).

In particular, as depicted in step 20 of FIG. 3, when the over-the-top (OTT) application server 320 detects a termination of signaling or service on the client user equipment (UE) 300, the over-the-top (OTT) application server 320 attempts to establish a mutually authenticated (client 300 and server 320) TLS/SSL connection with the quality of service (QoS) server 100 (following standard TLS/SSL procedures for mutual authentication).

As portrayed in step 21, if the initial mutual authentication step is successful, the over-the-top (OTT) application server 320 sends a quality of service (QoS) termination message to the quality of service (QoS) server 100.

In accordance with the principles of the present invention, a quality of service (QoS) termination message preferably includes: a message ID (an identifier defined by, and unique to, a requesting over-the-top (OTT) application), an application identifier (as described in 3GPP series 29.214 specification), access credentials (e.g. a secret/password public key infrastructure (PKI) verification, etc.), a quality of service (QoS) application profile ID, a source framed IP address (an attribute-value part (AVP)) or framed IPv6 prefix (an attribute-value part (AVP), RFC 4005 [12]), a service uniform resource name (URN) (an attribute-value part (AVP), 3GPP 29.214), a reservation priority (TS 183.017 [15]) (a vendor is preferably set to european telecommunications standards institute (ETSI) (13019) [15]), and a subscription ID (RFC 4006 [14]), identifying a particular subscription, e.g., international mobile subscriber identity (IMSI), mobile station integrated services digital network (MSISDN), etc.

In response to a quality of service (QoS) termination message, the quality of service (QoS) server 100 performs quality of service (QoS) termination validation, as portrayed in step 22. During quality of service (QoS) termination validation, the quality of service (QoS) server 100 validates an application identifier and access credentials (e.g., a secret/password public key infrastructure (PKI) verification, etc.) received in the quality of service (QoS) termination message, against application profile data maintained in a local application information database 220.

As depicted in step 23, once quality of service (QoS) termination validation is complete, the quality of service (QoS) server 100 sends a diameter session termination request (STR) message to the policy and charging rules function (PCRF) 104 on the client device's 300 home mobile network operator (MNO), to indicate that service/signaling has been terminated.

In steps 24 and 25, the policy and charging rules function (PCRF) 104 responds to the quality of service (QoS) server 100 with a diameter session termination answer (STA) message, and the quality of service (QoS) server 100 subsequently sends a quality of service (QoS) response message (including an appropriate status value) to the requesting over-the-top (OTT) application server 320.

The present invention has particular applicability to United States federal agencies, such as the Federal Emergency Management Agency (FEMA), and the Department of Homeland Security (DHS), etc., as well as to emergency first responders, large over-the-top (OTT) application providers (e.g., Google™, Apple™, etc.), and enhanced long term evolution (LTE) policy and charging rules function(s) (PCRF), from policy and charging rules function (PCRF) vendors.

Inventive quality of service (QoS) logic may and should be extended to support other scenarios, such as scenarios described as “Application Function” logic in 3GPP series 29 specifications.

While the invention has been described with reference to the exemplary embodiments thereof, those skilled in the art will be able to make various modifications to the described embodiments of the invention without departing from the true spirit and scope of the invention.

What is claimed is:

1. A quality of service (QoS) server for extending quality of service (QoS) treatment to an over-the-top (OTT) application on a commercial wireless network, comprising:
an over-the-top (OTT) application interface for interfacing with an over-the-top (OTT) application server;
a mobile network operator (MNO) policy and charging rules function (PCRF) interface for interfacing with a policy and charging rules function (PCRF) on a home mobile network operator (MNO) assigned to an over-the-top (OTT) application client device;
a number portability database (NPDB) interface for interfacing with an external number portability database (NPDB);
a local application information database to store profiles and information for supported over-the-top (OTT) applications; and
a local mobile network operator (MNO) information database to store home mobile network operator (MNO) information for supported over-the-top (OTT) application clients.

2. The quality of service (QoS) server for extending quality of service (QoS) treatment to an over-the-top (OTT) application on a commercial wireless network according to claim 1, wherein:
said mobile network operator (MNO) policy and charging rules function (PCRF) interface is a diameter protocol interface.

3. The quality of service (QoS) server for extending quality of service (QoS) treatment to an over-the-top (OTT) application on a commercial wireless network according to claim 1, wherein:
said over-the-top (OTT) application interface is a secure transport layer security (TLS)/secure sockets layer (SSL) communications channel.

4. The quality of service (QoS) server for extending quality of service (QoS) treatment to an over-the-top (OTT) application on a commercial wireless network according to claim 1, wherein:
said quality of service (QoS) server translates received diameter protocol messages to other communication mediums and vice versa.

5. The quality of service (QoS) server for extending quality of service (QoS) treatment to an over-the-top (OTT) application on a commercial wireless network according to claim 1, wherein:
said over-the-top (OTT) application server requests and gets desired quality of service (QoS) treatment from said quality of service (QoS) server for application data that is traversing a commercial wireless network.

6. The quality of service (QoS) server for extending quality of service (QoS) treatment to an over-the-top (OTT) application on a commercial wireless network according to claim 5, wherein:
said commercial wireless network is a long term evolution (LTE) network.

7. The quality of service (QoS) server for extending quality of service (QoS) treatment to over-the-top (OTT) applications on a commercial wireless network according to claim 5, wherein:
said commercial wireless network is a universal mobile telecommunications system (UMTS) network.

8. The quality of service (QoS) server for extending quality of service (QoS) treatment to an over-the-top (OTT) application for use on a commercial wireless network according to claim 5, wherein:
said commercial wireless network is a Wi-Fi network.

9. The quality of service (QoS) server for extending quality of service (QoS) treatment to an over-the-top (OTT) application on a commercial wireless network according to claim 1, wherein:
said over-the-top (OTT) application must provision one or more quality of service (QoS) application profiles on said quality of service (QoS) server before said over-the-top (OTT) application is permitted to request quality of service (QoS) treatment therefrom.

10. The quality of service (QoS) server for extending quality of service (QoS) treatment to an over-the-top (OTT) application on a commercial wireless network according to claim 9, wherein:
said quality of service (QoS) application profile indicates a desired level of quality of service (QoS).

11. The quality of service (QoS) server for extending quality of service (QoS) treatment to an over-the-top (OTT) applications on a commercial wireless network according to claim 1, wherein:
said over-the-top (OTT) application server sends a quality of service (QoS) request message to said quality of service (QoS) server to request quality of service (QoS) treatment therefrom.

12. The quality of service (QoS) server for extending quality of service (QoS) treatment to an over-the-top (OTT) application on a commercial wireless network according to claim 11, wherein:
said quality of service (QoS) request message must include a quality of service (QoS) application profile ID to indicate a particular quality of service (QoS) application profile to invoke.

13. The quality of service (QoS) server for extending quality of service (QoS) treatment to an over-the-top (OTT) application on a commercial wireless network according to claim 11, wherein:
said quality of service (QoS) server forwards desired quality of service (QoS) rules embedded in said quality of service (QoS) request message to a policy and charging rules function (PCRF) on a home mobile network operator (MNO) assigned to a corresponding over-the-top (OTT) application client device.

14. The quality of service (QoS) server for extending quality of service (QoS) treatment to an over-the-top (OTT) application on a commercial wireless network according to claim 1, wherein:
said quality of service (QoS) server queries said local mobile network operator (MNO) database to determine a home mobile network operator (MNO) for said over-the-top (OTT) application client device.

15. The quality of service (QoS) server for extending quality of service (QoS) treatment to an over-the-top (OTT) application on a commercial wireless network according to claim 1, wherein:
said quality of service (QoS) server queries said external number portability database (NPDB) to determine a home mobile network operator (MNO) for said over-the-top (OTT) application client device when home mobile network operator (MNO) information cannot be found in said local mobile network operator (MNO) database.

16. The quality of service (QoS) server for extending quality of service (QoS) treatment to an over-the-top (OTT) application on a commercial wireless network according to claim 13, wherein:
said home policy and charging rules function (PCRF) provides conventional quality of service (QoS) treatment to said over-the-top (OTT) application.

17. The quality of service (QoS) server for extending quality of service (QoS) treatment to an over-the-top (OTT) application on a commercial wireless network according to claim 13, wherein:
said policy and charging rules function (PCRF) on said home mobile network operator (MNO) forwards desired quality of service (QoS) rules to a policy and charging rules function (PCRF) on a visiting mobile network operator (MNO) when an over-the-top (OTT) application client device is roaming.

18. The quality of service (QoS) server for extending quality of service (QoS) treatment to an over-the-top (OTT) application on a commercial wireless network according to claim 17, wherein:
said serving policy and charging rules (PCRF) provides conventional quality of service (QoS) treatment to said over-the-top (OTT) application.

19. The quality of service (QoS) server for extending quality of service (QoS) treatment to an over-the-top (OTT) application on a commercial wireless network according to claim 1, wherein:
said over-the-top (OTT) application server sends a quality of service (QoS) termination message to said quality of service (QoS) server when said over-the-top (OTT) application server detects a termination of service or signaling on said over-the-top (OTT) application client.

20. The quality of service (QoS) server for extending quality of service (QoS) treatment to an over-the-top (OTT) application on a commercial wireless network according to claim 19, wherein:
said quality of service (QoS) termination message indicates to said quality of service (QoS) server that reserved quality of service (QoS) values may be terminated on said home mobile network operator (MNO) assigned to said over-the-top (OTT) application client device.

21. A method for extending quality of service (QoS) treatment to an over-the-top (OTT) application on a commercial wireless network, comprising:
receiving a quality of service (QoS) request message from an over-the-top (OTT) application server;
performing quality of service (QoS) request validation on said quality of service (QoS) request message attributes;
querying a local mobile network operator (MNO) information database for a home mobile network operator (MNO) assigned to an over-the-top (OTT) application client device;
using a quality of service (QoS) application profile ID embedded in said received quality of service (QoS) request message to determine if said over-the-top (OTT) application is permitted to influence quality of service (QoS) settings on said home mobile network operator (MNO);
sending appropriate quality of service (QoS) information to a policy and charging rules function (PCRF) on said home mobile network operator (MNO) when said over-the-top (OTT) application is permitted to influence quality of service (QoS) settings on said home mobile network operator (MNO); and
returning a quality of service (QoS) response message to said over-the-top (OTT) application server with an appropriate status identifier.

22. The method for extending quality of service (QoS) treatment to an over-the-top (OTT) application on a commercial wireless network according to claim 21, wherein:
said policy and charging rules function (PCRF) provides conventional quality of service (QoS) treatment to said over-the-top (OTT) application.

23. The method for extending quality of service (QoS) treatment to an over-the-top (OTT) application on a commercial wireless network according to claim 21, wherein:
an external number portability database (NPDB) is queried for home mobile network operator (MNO) information when home mobile network operator (MNO) information cannot be found in said local mobile network operator (MNO) information database.

23. The method for extending quality of service (QoS) treatment to an over-the-top (OTT) application on a commercial wireless network according to claim 21, wherein:
said quality of service information is sent to said policy and charging rules function (PCRF) via a diameter protocol interface.

24. The method for extending quality of service (QoS) treatment to an over-the-top (OTT) application on a commercial wireless network according to claim 21, wherein:
said policy and charging rules function (PCRF) on said home mobile network operator (MNO) forwards received quality of service (QoS) rules to a policy and charging rules function (PCRF) serving said over-the-top (OTT) application client device when said (OTT) application client device is roaming.

25. The method for extending quality of service (QoS) treatment to an over-the-top (OTT) application on a commercial wireless network according to claim 21, wherein:
said quality of service (QoS) application profile ID indicates a particular quality of service (QoS) profile to invoke.

26. The method for extending quality of service (QoS) treatment to an over-the-top (OTT) application on a commercial wireless network according to claim 21, wherein:
said over-the-top (OTT) application server sends a quality of service (QoS) termination message to said quality of service (QoS) server when said over-the-top (OTT) application server detects a termination of service or signaling on said over-the-top (OTT) application client.

27. The method for extending quality of service (QoS) treatment to an over-the-top (OTT) application on a commercial wireless network according to claim 26, wherein:
said quality of service (QoS) termination message indicates to said quality of service (QoS) server that reserved quality of service (QoS) values may be terminated on said home mobile network operator (MNO) assigned to said over-the-top (OTT) application client device.
